(19) United States
(12) Patent Application Publication
(10) Pub. No.: US 2012/0015108 A1
(43) Pub. Date: Jan. 19, 2012

(54) Composition Containing A Silicon-Containing Compound

(76) Inventors: Marie-Jose Sarrazin, Waterloo (BE); Andreas Stammer, Pont-a-celles (BE); Donald Liles, Midland, MI (US); David Selley, Bay City, MI (US)

(21) Appl. No.: 13/125,764

(22) PCT Filed: Oct. 20, 2009
(86) PCT No.: PCT/EP09/63752

§ 371 Date: Sep. 28, 2011

(30) Foreign Application Priority Data
Oct. 24, 2008 (US) US 61/108049
Oct. 20, 2009 (EP) PCT/EP2009/063752

(51) Int. Cl. B05D 5/00; C08K 5/5419; B05D 3/00

(52) U.S. Cl. 427/299; 524/266

(57) ABSTRACT

The invention provides a composition for improving the water repellency of a substrate, like a construction substrate for example a building component. This composition contains a mixture formed by combining: water, at least one water-repellent silicon-containing compound, which is a silicone resin, an alkoxysilane or a polysiloxane, a siloxane surfactant containing an alkylpoly(ethyleneoxy)siloxane group and an alkyl siloxane group, where the alkyl group contains 1-6 carbon atoms. The composition can be used on previous treated substrates or more generally on substrates which are difficult to wet or penetrate.

### TECHNICAL FIELD

The present invention relates to a composition for improving the water repellency of a substrate, which composition contains a silicon-containing compound.

### BACKGROUND

Imparting or improving water repellency of a substrate is desired for a number of substrates including organic or inorganic building components, for example, concrete, masonry, stucco, natural or artificial stone, ceramic, terracotta bricks, plaster board, fiber cement board, or other cement containing products, wood particle board, wood plastic composites, oriented strand board (OSB) or wood.

The desired water repellency properties are usually obtained by applying a water-repellent composition to the external surface of a substrate so as to create a water repellent coating on the substrate which protects this substrate from weathering and other deterioration. At least the outermost surface of building materials is treated in order to become waterproof.

Silicone compounds are used as water repellents since years due to their durability, good hydrophobicity and ease of application. First, silicone resins in solvent and methylsiliconates were used as silicone water repellent compounds. Then followed siloxane and silane based products in solvents. Next generation of water repellents is generally water based for environmental reasons and ease of use. The active ingredients contain siloxanes, silicone resins and silanes (and combinations of them). For example, U.S. Pat. No. 6,323,268 describes a composition for rendering surfaces water repellent formed by combining water or a solvent, a methylhydrogensiloxane polymer or copolymer, an alkoxysilane having the formula RₐSi(OR′)₄₋ₐ in which R represents an alkyl group containing 1-10 carbon atoms, an alkenyl group containing 2-8 carbon atoms, an aryl group, or an haloalkyl group, a has a value of 1 or 2, and R′ represents an alkyl group containing 1-6 carbon atoms; and a silicone resin.

Solvent based products generally show good wetting and penetration to untreated (new) substrates as well as to previously treated substrates. On the other hand, water based products are not always as successful regarding substrate penetration and wetting of formerly treated surfaces. This limits the efficiency of water based water repellent products.

For example, construction substrates are often treated with water repellents to prevent the ingress of water. While today products exist which can provide protection of 10 years and more past products were less durable or less performing products were used for cost reasons. Also treatments may be partially removed when substrates are cleaned for aesthetic reasons for example by sandblasting or high pressure water wash. This kind of surface had to be treated with solvent based products up to now as the only reliable solutions guaranteeing homogenous treatment and durable performance.

Surprisingly it was found that mixtures containing a water-repellent silicon-containing compound together with water and a defined type of siloxane surfactant can improve significantly both substrate penetration and wetting of formerly treated substrates, while keeping the ability to provide and maintain a water-repellent surface.

### SUMMARY

Therefore, in one of its aspects, the present invention provides a composition able to improve the water repellency of a substrate, which composition contains a mixture formed by combining;
I water,
II at least one silicon containing compound able to improve water repellency of a substrate, which is a silicone resin, an alkoxysilane or a polysiloxane,
III a siloxane surfactant containing:
   i an alkylpoly(ethyleneoxy)siloxane group and
   ii an alkyl siloxane group, where the alkyl part contains 1-6 carbon atoms
IV optionally an emulsifier.

This composition can provide water based durable silicone water repellents that can be used on previous treated substrates or more generally on substrates which are difficult to wet or penetrate. The latter, is needed to provide the desired durability since surfaces are often subject to wear and erosion.

### DETAILED DESCRIPTION

As hereinbefore described the mixture is formed (obtained) i.e. is obtainable by combining components I, II, III and IV. The water repellent silicon-containing compound (II). This component (II) of the composition comprises at least one silicon containing compound able to improve water repellency of a substrate. This water repellent silicon-containing compound is chosen amongst silicone resin (component A), an alkoxysilane (component B), and a polysiloxane (component C).

In some embodiments, the component (II) is a mixture of at least 2 of the following: silicone resin (component A), an alkoxysilane (component B), and a polysiloxane (component C).

### (A) The Silicone Resin

The silicone resin can be any one of the various types of resinous copolymers described in detail in U.S. Pat. No. 5,695,551 (Dec. 9, 1999). However, most preferred for use herein are those resinous copolymers described as:
1. A resinous copolymeric siloxane prepared by a method comprising (i) forming an acidic homogeneous mixture of a silanol containing resinous copolymeric siloxane with R″₃SiO_{1/2} units and SiO_{4/2} units; an organohydrogen polysiloxane with the formula R″_{b}H_{c}SiO_{(4-b-c)/2} where b and c are positive integers with a sum less than four, preferably 1.9-2.1; and an organic solvent, and (ii) heating the mixture to remove substantially all organic solvent. R″ can be an alkyl group with 1-6 carbon atoms; an aryl group such as phenyl, tolyl, and xylyl; an alkenyl group such as vinyl and allyl; or a trifluoropropyl group. R″ can also be an arylalkyl group such as betaphenylethyl and betaphenylpropyl; or a cycloaliphatic group such as cyclopentyl, cyclohexyl, and cyclohexenyl; and
2. A siloxane resin copolymer comprising R″₃SiO_{1/2} units and SiO_{4/2} units in a mole ratio such that the number average molecular weight is 1,200 to 10,000 g/mol. Preferably, the molar ratio is 0.7:1.0, and the number average molecular weight is 5,000 g/mol. R″ is defined immediately above. This resin contains 2.5 weight percent silicon bonded OH groups. The resin may also contain R″₂SiO_{2/2} units and R″SiO_{3/2} units.

One silicone resin representative of such resinous copolymers which is especially preferred for use herein is a siloxane resin copolymer consisting essentially of (CH_{3 3}SiO_{1/2} units and SiO₂ units in a molar ratio of approximately 0.75:1 containing 2.4 to 2.9 weight percent of hydroxy, based on solids as determined by FTIR according to the American Society for Testing & Materials (ASTM) Test Procedure E-168.

Component (A) can be a phenyl silsesquioxane resin, or a mixture of phenyl silsesquioxanes. As used herein, a phenyl silsesquioxane resin is an organopolysiloxane having at least one siloxy unit of the formula (C₆H₅SiO_{3/2}). Organopolysiloxanes are polymers containing siloxy units independently selected from (R₃SiO_{1/2}), (R₂SiO_{2/2}), (RSiO_{3/2}), or (SiO_{4/2}) siloxy units (also referred herein as M, D, T, or Q units respectively), where R may be any monovalent organic group. These siloxy units can be combined in various manners to form cyclic, linear, or branched structures. The chemical and physical properties of the resulting polymeric structures can vary. For example, organopolysiloxanes can be volatile or low viscosity fluids, high viscosity fluids/gums, elastomers or rubbers, and resins, depending on the selection and amount of each siloxy unit in the organopolysiloxane. Silsesquioxanes are typically characterized as having at least one or several (RSiO_{3/2}) or T siloxy units. Thus, the organopolysiloxanes suitable as component A) in the present disclosure may have any combination of (R₃SiO_{1/2}), (R₂SiO_{2/2}), (RSiO_{3/2}), or (SiO_{4/2}) siloxy units, providing it has at least one siloxy unit of the formula (C₆H₅SiO_{3/2}), where C₆H₅ represents a phenyl group.

The phenyl silsesquioxane resin may have an average formula comprising at least 40 mole % of siloxy units having the formula (R′₂SiO_{2/2})ₓ(C₆H₅SiO_{3/2})_{y}, where x and y have a value of 0.05 to 0.95, and R′ is a monovalent hydrocarbon group having 1 to 8 carbon atoms. As used herein, x and y represent the mole fraction of (R′₂SiO_{2/2}) and (C₆H₅SiO_{3/2}) siloxy units (i.e. D and T-phenyl siloxy units) relative to each other present in the phenyl silsesquioxane resin.

Thus, the mole fractions of (R′₂SiO_{2/2}) and (C₆H₅SiO_{3/2})siloxy units each can independently vary from 0.05 to 0.95. However, the combination of (R′₂SiO_{2/2}) and (C₆H₅SiO_{3/2}) siloxy units present must total at least 40 mole %, alternatively 80 mole %, or alternatively 95 mole % of all siloxy units present in the phenyl silsesquioxane resin. R′ can be a linear or branched alkyl such as ethyl, propyl, butyl, pentyl, hexyl, heptyl, or octyl group. Typically, R′ is methyl.

The phenyl silsesquioxane resins can contain additional siloxy units such as (i) (R¹₃SiO_{1/2})ₐ, (ii) (R²₂SiO_{2/2})_{b}, (iii) (R³SiO_{3/2})_{c}, or (iv) (SiO_{4/2})_{d} units which are commonly known in the art, and also used herein, as M, D, T, and Q units respectively. The amount of each unit present in the phenyl silsesquioxane resin can be expressed as a mole fraction of the total number of moles of all siloxy units present in the phenyl silsesquioxane resin. Thus, the phenyl silsesquioxane resin of the present invention can comprise the units:

### (i) (R¹₃SiO_{1/2})ₐ

### (ii) (R²₂SiO_{2/2})_{b}

(iii) (R³SiO_{3/2})_{c},
(iv) (SiO_{4/2})_{d},

### (v) (R′₂SiO_{2/2})ₓ and

(vi) (C₆H₅SiO_{3/2})_{y},
wherein
R¹, R², and R³ are independently an alkyl group having from 1 to 8 carbon atoms, an aryl group, or a carbinol group, R′ is a monovalent hydrocarbon group having 1-8 carbon atoms, a, b, c, and d have value of zero to 0.6, x and y each have a value of 0.05 to 0.95, with the provisos that the value of x+y is equal to or greater than 0.40, and the value of a+b+c+d+x+y=1.

The R¹, R², and R³ in the units of the phenyl silsesquioxane resin are independently an alkyl group having from 1 to 8 carbon atoms, an aryl group, a carbinol group, or an amino group. The alkyl groups are illustrated by methyl, ethyl, propyl, butyl, pentyl, hexyl, and octyl. The aryl groups are illustrated by phenyl, naphthyl, benzyl, tolyl, xylyl, xenyl, methylphenyl, 2-phenylethyl, 2-phenyl-2-methylethyl, chlorophenyl, bromophenyl and fluorophenyl with the aryl group typically being phenyl. For the purposes of this invention a “carbinol group” is defined as any group containing at least one carbon-bonded hydroxy (C—OH) group. Thus the carbinol groups may contain more than one C—OH radical such as for example

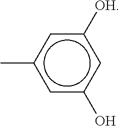

The carbinol group if free of aryl groups has at least 3 carbon atoms, or an aryl-containing carbinol group having at least 6 carbon atoms. The carbinol group free of aryl groups having at least 3 carbon atoms is illustrated by groups having the formula R⁴OH wherein R⁴ is a divalent hydrocarbon radical having at least 3 carbon atoms or divalent hydrocarbonoxy radical having at least 3 carbon atoms. The group R⁴ is illustrated by alkylene radicals such as —(CH₂)_{X}— where x has a value of 3 to 10, —CH₂CH(CH₃)—, —CH₂CH(CH₃)CH₂—, —CH₂CH₂CH(CH₂CH₃)CH₂CH₂CH₂—, and —OCH(CH₃)(CH₂)_{X}— wherein x has a value of 1 to 10.

The aryl-containing carbinol group having at least 6 carbon atoms is illustrated by groups having the formula R⁵OH wherein R⁵ is an arylene radical such as —(CH₂)_{X}C₆H₄— wherein x has a value of 0 to 10, —CH₂CH(CH₃)(CH₂)_{X}C₆H₄— wherein x has a value of 0 to 10, —(CH₂)_{X}C₆H₄(CH₂)_{X}— wherein x has a value of 1 to 10. The aryl-containing carbinol groups typically have from 6 to 14 atoms.

Typically, R¹ is a methyl group, R² is a methyl or phenyl group, and R³ is a methyl group.

Any individual D, T or Q siloxane units of the phenyl silsesquioxane resins can also contain a hydroxy group and/or alkoxy group. Such siloxane units containing hydroxy and/or alkoxy groups are commonly found in siloxane resins having the general formula RₙSiO_{(4-n)/2}. The hydroxy groups in these siloxane resins typically result from the reaction of the hydrolysable group on the siloxane unit with water. The alkoxy groups result from incomplete hydrolysis when alkoxysilane precursors are used or from exchange of alcohol with hydrolysable groups. Typically, the weight percent of the total hydroxy groups present in the phenyl silsesquioxane resin is up to 40 wt %.

The molecular weights of the phenyl silsesquioxane resins are not restricted, but typically the number average molecular weight (M_{N}) (as determined following ASTM D5296-05 and calculated as polystyrene molecular weight equivalents) range from 500 to 10,000, or alternatively from 500 to 2,000 g/mol.

The viscosity of the phenyl silsesquioxane at 25° C. is not restricted, but typically the viscosity should be lower than 100 mPa·s (cP), alternatively range from 10 mPa·s (cP) to 50 mPa·s (cP). A phenyl silsesquioxane having a higher viscosity in the aqueous silicone emulsion may not be as readily coated on a substrate. However, resins having a higher viscosity at 25° C. may be used if dissolved in a solvent, as described below as solvents for their preparation.

The phenyl silsesquioxane resins of the present disclosure may be prepared by any method known in the art for preparing siloxane resins having the general formula RₙSiO_{(4-n)/2} where R is an alkyl or aryl group and n is generally less than 1.8. Thus, the phenyl silsesquioxane resins can be prepared by co-hydrolyzing at least one phenylsilanephenyls lane having three hydrolysable groups such as a halogen or alkoxy group present in the silane molecule with other selected alkylsilanes having two or three hydrolysable groups such as a halogen or alkoxy group present in the silane molecule. For example, the phenyl silsesquioxane resins can be obtained by co-hydrolyzing alkoxysilanes, such as dimethyldiethoxysilane with phenyltrimethoxysilane, phenyltriethoxysilane, or phenyltripropoxysilane. Alternatively, alkylchlorosilanes may be co-hydrolyzed with phenyltrichlorosilane to produce the phenyl silsesquioxane resins of the present invention. Typically, the co-hydrolysis is performed in an alcohol or hydrocarbon solvent. Alcohols suitable for these purposes include methanol, ethanol, n-propyl alcohol, isopropyl alcohol, butanol, methoxy ethanol, ethoxy ethanol, or similar alcohols. Examples of hydrocarbon-type solvents which can also be concurrently used include toluene, xylene, or similar aromatic hydrocarbons; hexane, heptane, isooctane, or similar linear or partially branched saturated hydrocarbons; and cyclohexane, or similar aliphatic hydrocarbons.

The additional M, D, T, and Q units, as described supra, can be introduced into the phenyl silsesquioxane resins by reacting an additional organosilane(s), selected to produce the desired siloxy unit in the resulting resin during the co-hydrolysis of the alkylsilane and phenylsilane. For example, reacting methoxytrimethylsilane, dimethoxydimethylsilane, trimethoxymethylsilane, tetramethoxysilane (or alternatively the corresponding ethoxy or chlorosilane of each) will respectively introduce a M, D, T, or Q unit into the alkyl-phenyl silsesquioxane resin. The amount of these additional silanes present in the co-hydrolysis reaction are selected to meet the mole fraction definitions, as described supra.

Alternatively, the phenyl silsesquioxane resins can be prepared by reacting an organopolysiloxane and a phenyl silsesquioxane resin using any method in the art known to effect reaction of M, D, T, and Q siloxane units. For example, a diorganopolysiloxane and a phenyl silsesquioxane resin can be reacted by a condensation reaction in the presence of a catalyst. Typically the starting resins are contained in an aromatic hydrocarbon or siloxane solvent. Suitable condensation reaction catalysts are base catalysts including metal hydroxides such as potassium hydroxide and sodium hydroxide; metal salts such as silanolates, carboxylates, and carbonates; ammonia; amines; and titanates such as tetrabutyl titanates; and combinations thereof. Typically, the reaction of siloxane resins is affected by heating the reaction mixture to temperatures ranging from 50 to 140° C., alternatively 100 to 140° C. The reaction can be conducted in a batch, semi-continuous, or continuous process.

The phenyl silsesquioxane resins of this invention are illustrated by phenyl silsesquioxane resins comprising the units;

((CH₃)₂SiO_{3/2})ₓ(C₆H₅SiO_{3/2})_{y}

wherein x and y each have a value of 0.05 to 0.95, with the proviso that the value of x+y is equal to or greater than 0.40.

Optionally, the phenyl silsesquioxane resin can be dissolved in a solvent. A volatile siloxane or organic solvent can be selected as optional component for dissolving or dispersing the phenyl silsesquioxane resin before addition to the aqueous emulsion composition. Any volatile siloxane or organic solvent can be selected providing component A) is dispersible or miscible with the selected solvent. The volatile siloxane solvent can be a cyclic polysiloxane, a linear polysiloxane, or mixtures thereof. Some representative volatile linear polysiloxanes are hexamethyldisiloxane, octamethyltrisiloxane, decamethyltetrasiloxane, tetradecamethylhexasiloxane, and hexadecamethylheptasiloxane. Some representative volatile cyclic polysiloxanes are hexamethylcyclotrisiloxane, octamethylcyclotetrasiloxane, decamethylcyclopentasiloxane, and dodecamethylcyclohexasiloxane. The organic solvent can be an ester, an alcohol such as methanol, ethanol, isopropanol, butanol, or n-propanol, a ketone such as acetone, methylethyl ketone, or methyl isobutyl ketone; an aromatic hydrocarbon such as benzene, toluene, or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether, an acetate, such as ethyl acetate or butyl acetate, a halogenated hydrocarbon such as dichloromethane, 1,1,1-trichloroethane or methylene chloride, chloroform, dimethyl sulfoxide, dimethyl formamide, acetonitrile, tetrahydrofuran, or an aliphatic hydrocarbon such as white spirits, mineral spirits, isododecane, heptane, hexane or naphtha.

Commercially available phenyl silsesquioxane resins that are suitable as component (A) in silicone emulsions as presently disclosed include the following representative, non-limiting examples; DOW CORNING® 3037 Intermediate and DOW CORNING® 3074, (Dow Corning Corp., Midland, Mich.).

Preferably, water-repellent silicon containing compound contains a silicone resin compound which is a MQ or RSiO_{3/2} resin where R is hydrogen, aryl or alkyl with 1-12 carbon atoms.

### (B) The Alkoxysilane

The alkoxysilane can constitute a single alkoxysilane or a mixture of alkoxysilanes can be employed. The alkoxysilane may have the formula R⁸ₐSi(OR⁹)₍₄₋ₐ₎ In the formula, R⁸ represents an alkyl group having 1-30 carbon atoms, alternatively 1-12 carbon atoms, an aryl group such as phenyl, or an haloalkyl group such as chloropropyl and trifluoropropyl. The value of a is 1 or 2, and R⁹ represents an alkyl group having 1-6 carbon atoms. Typically, R⁸ is n-octyl, and R⁹ is methyl or ethyl.

Preferably, the alkoxysilane compound (B) is alkyltrialkoxysilane with 1-12 carbon atoms in the alkyl chain and 1-6 carbons in the alkoxy chain. Some suitable alkoxysilanes are methyltrimethoxysilane, methyltriethoxysilane, methyltripropoxysilane, ethyltrimethoxysilane, ethyltributoxysilane, propyltrimethoxysilane, propyltriethoxysilane, isobutyltrimethoxysilane, isobutyltriethoxysilane, butyltriethoxysilane, hexyltrimethoxysilane, n-octyltriethoxysilane, iso-octyltriethoxysilane, n-octyltrimethoxysilane, iso-octyltrimethoxysilane dimethyldimethoxysilane, dimethyldiethoxysilane, diethyldimethoxysilane, diisobutyldimethoxysilane, phenyltrimethoxysilane, dibutyldiethoxysilane, and dihexyldimethoxysilane.

Such alkoxysilanes are commercially available from the Dow Corning Corporation, Midland, Mich., and are described, for example, in U.S. Pat. No. 5,300,327 (Apr. 5, 1994), U.S. Pat. No. 5,695,551 (Dec. 9, 1997), and U.S. Pat. No. 5,919,296 (Jul. 6, 1999). The alkoxysilane can be partially hydrolysed therefore containing siloxane and/or silanol groups.

### (C) The Polysiloxane

Compound (C) is preferably a polydialkylsiloxane having the general formula;

[R⁹₂Si(OR³)O_{1/2}][R⁹₂SiO_{2/2}]_{z}[SiR⁹₂(OR³)O_{1/2}],

where R¹ is as defined above and z represents the degree of polymerization and is greater than one. R³ is H in case of hydroxy terminated polymers or Si (CH₃)₃.

Typically, polydialkylsiloxane is a hydroxyl or trimethylsilyl terminated polydimethylsiloxane having a degree of polymerization (z) that is greater than 1, alternatively from 1 to 500, alternatively, from 5 to 200, or alternatively from 10 to 100.

More preferably, this polysiloxane compound which is a diorganosiloxane with 1-12 carbon atoms per organic group.

### Siloxane Surfactant (III)

Siloxane surfactant (III) is a siloxane compound which contains an alkylpoly(ethylenexoy) siloxane group associated with an alkyl siloxane group, where the alkyl group contains 1-6 carbon atoms. Such compound is able to promote wetting of various surfaces, particularly surfaces which are difficult to wet by water-based liquid compositions.

The siloxane compound III is preferably a compound of low molecular weight. Preferably, it contains between 2 and 8 silicon atoms. Such siloxane compounds III are known as wetting agents. They can enhance spreading of composition, for example in agriculture applications is described on pages 19 to 23 of the book “Silicone surfactants” by R. M. Hill (Marcel Dekker 1999). For example, U.S. Pat. No. 4,933,002 describes an herbicide composition containing an herbicide, an acetoxy-terminated silicone glycol and a silicone dispersant which is typically an ethoxylated trisiloxane.

Preferably, the siloxane compound (III) contains 1-3 alkylpoly(ethyleneoxy)siloxane groups (i) and 1 to 4 alkyl-siloxane groups (ii). More preferably, the siloxane compound (III) is a trisiloxane containing one alkylypoly(ethyleneoxy)siloxane group (i) and two methyl- and/or ethyl-siloxane groups (ii). Preferably, the average number of ethyleneoxy (EO) units in the alkylpoly(ethyleneoxy) siloxane group (ii) is comprised between 5 and 12. Preferably, the end unit of the alkylpoly(ethyleneoxy) siloxane group (ii) is an acetoxy, hydroxyl or methoxy unit.

Trisiloxane surfactants are described in U.S. Pat. No. 3,299,112

A typical not limiting formula for a trisiloxane surfactant is given below

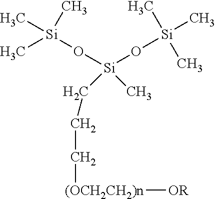

### Where:

n=3-20
R=H, CH₃, CH₃CH₂, CH₃CO

Other R groups can be used and the length of the alkyl chain between the Si Atom and the EO chain may vary from 1 to 12 carbons, for example 3 carbon atoms thereby forming a propyl link between the Si atom and the EO chain.

In the examples, a trisiloxane corresponding to the above formula with n being 7 and R being H is used. Therefore, preferably, the siloxane compound (III) is a trisiloxane containing two groups (ii) wherein the alkyl parts are methyl, and one group (i) with an average number of ethyleneoxy (ED) units of 7 and an hydroxyl end unit.

Preferably, the composition is emulsified. Typically, the aqueous silicone emulsions of the present disclosure are water continuous emulsions having a dispersed phase, for example of average particle size distribution that is less than 20 micrometers

### The Optional Emulsifier (IV)

Component IV is an emulsifier. As used herein, an “emulsifier” means any surfactant or mixture of surfactants having the ability to stabilize an aqueous emulsion. The surfactant may be an anionic surfactant, cationic surfactant, nonionic surfactant, amphoteric surfactant, or a mixture of surfactants. Nonionic surfactants and anionic surfactants are typically used and mixtures containing two nonionic surfactants are also typically used. When mixtures containing nonionic surfactants are used, one nonionic surfactant may have a low Hydrophile-Lipophile Balance (HLB) and the other nonionic surfactant may have a high HLB, such that the two nonionic surfactants have a combined HLB of 11-15, preferably a combined HLB of 12.5-14.5 (measured using the standard HLB method).

Representative examples of suitable anionic surfactants include alkali metal soaps of higher fatty acids, alkylaryl sulphonates such as sodium dodecyl benzene sulphonate, long chain fatty alcohol sulphates, olefin sulphates and olefin sulphonates, sulphated monoglycerides, sulphated esters, sulphonated ethoxylated alcohols, sulphosuccinates, alkane sulphonates, phosphate esters, alkyl isethionates, alkyl taurates, and alkyl sarcosinates. One example of a preferred anionic surfactant is sold commercially under the name Bio-Soft N-300. It is a triethanolamine linear alkylate sulphonate composition marketed by the Stephan Company, Northfield, Ill.

Representative examples of suitable cationic surfactants include alkylamine salts, quaternary ammonium salts, sulphonium salts, and phosphonium salts. Representative examples of suitable nonionic surfactants include condensates of ethylene oxide with long chain fatty alcohols or fatty acids such as a C₁₂₋₁₆ alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, and fatty amine oxides. Representative examples of suitable amphoteric surfactants include imidazoline Representative examples of suitable commercially available nonionic surfactants include polyoxyethylene fatty alcohols sold under the tradename BRIJ by Uniqema (ICI Surfactants), Wilmington, Del. Some examples are BRIJ 35 Liquid, an ethoxylated alcohol known as polyoxyethylene (23) lauryl ether, and BRIJ 30, another ethoxylated alcohol known as polyoxyethylene (4) lauryl ether. Some additional nonionic surfactants include ethoxylated alcohols sold under the trademark TERGITOL® by The Dow Chemical Company, Midland, Mich. Some example are TERGITOL® TMN-6, an ethoxylated alcohol known as ethoxylated trimethylnonanol; and various of the ethoxylated alcohols, i.e., C₁₂-C₁₄ secondary alcohol ethoxylates, sold under the trademarks TERGITOL® 15-S-5, TERGITOL® 15-S-12, TERGITOL® 15-S-15, and TERGITOL® 15-S-40. Surfactants containing silicon atoms can also be used.

Other optional ingredients may be added to the aqueous silicone emulsions of the present disclosure as desired to affect certain performance properties, providing the nature and/or quantity of these optional ingredients does not substantially destabilize the aqueous silicone emulsions. These optional ingredients include, fillers, freeze-thaw additives such as ethylene glycol or propylene glycol, antimicrobial preparations, UV filters, antioxidants, thickener, corrosion inhibitors, pH buffers, pigments, dyes, and perfumes.

Preferably, at least 1 part of siloxane surfactant (III) is incorporated in the composition for 100 weight parts water repellent compound (II). More preferably at least 2 by weight of siloxane (III) towards water repellent component (II) are used. Surprisingly, such small amounts permits to significantly enhance the water repellency properties of substrates treated with the composition, as will be shown in the examples. It is unnecessary to add more than 10% of siloxane surfactant (III) towards water repellent component (III).

In another aspect, the present invention provides a process to improve the water repellency of a substrate by applying to its surface a composition containing a mixture formed by combining;
I water,
II at least one silicon containing compound able to improve water repellency of a substrate (hereinafter called a water-repellent silicon-containing compound), which is a silicone resin, an alkoxysilane or a polysiloxane,
III a siloxane compound containing at least the following groups:
   i an alkylpoly(ethyleneoxy)siloxane group and
   ii a alkyl siloxane group, where the alkyl group contains 1-6 carbon atoms
IV optionally an emulsifier.

Preferably the substrate is concrete, masonry, stucco, natural or artificial stone, ceramic, terracotta bricks, plaster board, fiber cement board, or other cement containing products, wood particle board, wood plastic composites, oriented strand board (OSB) or wood. The substrate may alternatively include textiles, fibers, nonwoven materials, fillers and/or any other materials suitable for treatment with silicone based water repellent coatings such as the composition in accordance with the present invention.

The composition according to the invention is particularly efficient in treating surfaces of substrates which were already previously treated with a hydrophobing agent. In the latter case it can be applied to the surface of a substrate previously treated with a hydrophobing agent.

In other embodiments, the composition may be applied to a (new) untreated substrate, especially those having a poor wettabilty or difficult to penetrate. This is for example the case for some types of wood which have a naturally high content of oils.

In yet another embodiment, the composition is added to the starting ingredients used to form the substrate, for example cement slurry or watery mixture of board components.

In another aspect, the invention provides a process of preparing an emulsion by

### 1 Combining:

I water,
II at least one silicon containing compound able to improve water repellency of a substrate (hereinafter called a water-repellent silicon-containing compound), which is a silicone resin, an alkoxysilane or a polysiloxane,
III a siloxane compound containing at least the following groups:
   i an alkylpoly(ethyleneoxy)siloxane group and
   ii a alkyl siloxane group, where the alkyl group contains 1-6 carbon atoms
IV optionally an emulsifier.
   2 Shearing the dispersion to form an emulsion,
   3 Admixing additional water and optionally additional ingredient.

The invention also extends to the use of the composition as defined above to improve water repellency of a substrate by applying the composition to the finished substrate or by including the composition during the production of the substrate.

The aqueous silicone emulsions as described above may be prepared by any techniques known in the art for preparation of water continuous emulsion (e.g. Inversion, high shear equipment like colloid mills, twin screw extruder).

Optionally, the aqueous silicone emulsions may be prepared by a process comprising;

### I Combining

A silicone resin,
B an alkoxysilane,
C polydialkylsiloxane,
D trisiloxane surfactant, and optionally
E additional surfactant
and water to form a dispersion,
   II Shearing the dispersion to form an emulsion,
   III Admixing additional water and alternative ingredient
   Alternatively, the trisiloxane surfactant can be added at any time to a silicone emulsion, for example during step III. This is convenient when one uses already made emulsions.

The formation of the dispersion in step (I) involves combining components A), B), C), and D) with water. The order of addition of these components is not critical, but typically components A), B), C), and D) are combined with mixing and then water added to the mixture to form the dispersion. Alternatively, some or all of the emulsifier D) may be combined with some portion of water before mixing with the other components. The amount of each component and water used is generally the total amounts as needed in the final emulsion composition. Typically, the dispersion is formed by mixing the various components by any method known in the art to effect mixing of viscous materials. The mixing may occur either as a batch, semi-continuous, or continuous process. Thus, the mixing may be provided by batch mixing equipments with medium/low shear which include change-can mixers, double-planetary mixers, conical-screw mixers, ribbon blenders, double-arm or sigma-blade mixers. Illustrative examples of continuous mixers/compounders include extruders single-screw, twin-screw, and multi-screw extruders, co-rotating extruders, such as those manufactured by Krupp Werner & Pfleiderer Corp (Ramsey, N.J.), and Leistritz (NJ); twin-screw counter-rotating extruders, two-stage extruders, twin-rotor continuous mixers, dynamic or static mixers or combinations of these equipments. Furthermore, mixing may occur using emulsification equipments as rotor-stator, colloid mills, homogenizers, and sonolators.

The temperature and pressure at which the mixing occurs to effect the formation of the dispersion is not critical, but generally is conducted at ambient temperature and pressures. Typically, the temperature of the mixture will increase during the mixing process due to the mechanical energy associated with shearing viscous materials. Thus, lower shear rates will cause less of a temperature increase. Typically, the temperature is controlled to be below 60° C. to minimize undesirable side reactions.

Step II in the process of the present disclosure involves shearing the dispersion resulting from step Ito form an emulsion. Shearing may be provided by known techniques and equipment such as rotor-stator, colloid mills, homogenizers, and sonolators. The formation of the emulsion may be confirmed by any known particle size measurement techniques. Typically, the average particle size of the emulsion formed in step II is less than 5 micrometers, alternatively less than 2 micrometers.

Upon forming the emulsion in step (II), component (E) if needed is then admixed to the emulsion. The mixing techniques used in step (III) are not critical. Typically, simple stirring techniques are sufficient to mix component (E) and the emulsion of step (II). Alternatively, any of the mixing techniques as described above may be used, providing the mixing does not adversely affect the stability of the emulsion.

### EXAMPLES

These examples are intended to illustrate the invention to one of ordinary skill in the art and should not be interpreted as limiting the scope of the invention set forth in the claims. All measurements and experiments were conducted at 23° C., unless indicated otherwise. All parts are parts by weight unless indicated otherwise.

### Example 1

### A. Preparation of an Aqueous Silicone Emulsion

In a beaker 40 parts of n-octyltriethoxysilane, 2 parts of a trisiloxane surfactant with an average of 7 ethyleneoxy (EO) units and 58 parts of deionized water were premixed with a IKA stirrer (propeller 400 rpm, 300s) and then emulsified with a Ultraturax® mixer (T25 basic IKA Labortechnick-Janke & Kunkel Speed 13 500 RPM) for 120s.

The resulting emulsion, contained 40% active content, was milky white with a particle size of 2.7 micrometers at the 50 percentile and 5.0 micrometers at the 90 percentile as measured by the Mastersizer (Malvern Instruments Ltd) in the volume mode.

### B. Preparation of an Aqueous Silicone Emulsion

In a beaker to a mixture of 20 parts of n-octyltriethoxysilane and 20 parts silanol terminated polydimethylsiloxane having a viscosity of 40 mPa·s, 2 parts of a trisiloxane surfactant with an average of 7 EO units and 58 parts of deionized water were added and premixed with a IKA stirrer (propeller 400 rpm, 300s) and them emulsified with a Ultraturax® mixer for 120s.

The resulting emulsion, contained 40% active content (the active content being the weight % of water repellent component (II) in the emulsion), was milky white with a particle size of 2.3 micrometers at the 50 percentile and 5.1 micrometers at the 90 percentile as measured by the Mastersizer (Malvern Instruments Ltd) in the volume mode.

### C. Performance Testing of a Water Repellents Emulsion on Mortar and Concrete

The emulsions from example 1a and b were diluted to 10% active content by dilution with deionized water and applied by brushing (one saturated coat) to dry bricks and concrete blocks.

The contact angle (using an I.T. concepts Tracker) and water absorption with a Rilem tube (a horizontal version graduated glass tube following Rilem test no. 11.4) were tested after 7 days storing at room temperature. The following results were obtained in Table 1

TABLE 1

| | 1a on | 1a on | 1b on | 1b on |
|---|---|---|---|---|
| Sample | concrete | brick | concrete | brick |
| Contact angle | 95 | 104 | 81 | 100 |
| (deg) | | | | |
| Water | 1a on | 1a on | 1b on | 1b on |
| absorption (ml) | concrete | brick | concrete | brick |
| 5 min | 0 | 0 | 0 | 0 |
| 30 min | 0 | 0 | 0 | 0 |
| 1 h (hour(s)) | 0 | 0 | 0 | 0 |
| 4 h | 0.2 | 0.1 | 0.1 | 0.1 |
| 8 h | 0.4 | 0.3 | 0.4 | 0.2 |
| 24 h | 1.2 | 1.2 | 0.7 | 0.5 |

Water absorption value at 24 hours for untreated substrates was >4 ml on brick and concrete.

The results showed that silicone water repellents prepared with trisiloxane with an average of 7 EO units as sole surfactant are efficient water repellents on neutral (brick) and alkaline (concrete) substrates.

### Example 2

### Hydrophobing Surfaces with Silicones or Organic Oils (Preparation of Pre-Treated Substrates)

The following surface treatments were carried out on bricks and concrete.
a) Treatment with a solution of 5% olive oil diluted in white spirit (by brushing, one saturated coat)
b) Treatment with a solution of 3% of a commercial silicone water repellent (Dow Corning® Z-6689) diluted in white spirit. (by brushing, one saturated coat)
c) Treatment with a solution of 0.5% potassium methylsiliconate diluted in water (by brushing, one saturated coat).

### Example 3

### Contact Angles on Hydrophobic Surfaces with Trisiloxane Surfactant Containing Water Repellents

To a commercial water based silicone water repellent (Dow Corning® 520 water repellent) containing alkoxysilane, non ionic emulsifier and methyl hydrogen polysiloxane, a trisiloxane surfactant with an average of 7 EO units was added in different quantities and compared to the product containing no additive. 10% active ingredient was used for all measurement. Contact angles were measured on the substrates described in example 2 after 30, 60 and 180 s.

TABLE 2

| | Water | Water repellent + | Water repellent + |
|---|---|---|---|
| Pre-treated Substrate | repellent ref | 0.25% trisiloxane | 0.5% trisiloxane |
| 2a concrete at 30 s | 62 | 39 | <20 |
| 2a concrete at 60 s | 60 | 37 | <20 |
| 2a concrete at 80 s | 58 | 33 | <20 |
| 2b concrete at 30 s | 57 | 46 | <20 |
| 2b concrete at 60 s | 55 | 42 | <20 |
| 2b concrete at 180 s | 50 | 36 | <20 |
| 2c concrete at 30 s | 68 | 48 | 0 |
| 2c concrete at 60 s | 62 | 33 | 0 |
| 2c concrete at 180 s | 55 | <20 | 0 |
| 2a brick at 30 s | 75 | 52 | 42 |
| 2a brick at 60 s | 74 | 50 | 41 |
| 2a brick at 180 s | 68 | Not measured | 38 |
| 2b brick at 30 s | 68 | 60 | 37 |
| 2b brick at 60 s | 66 | 60 | 36 |
| 2b brick at 180 s | 62 | Not measured | <20 |
| 2c brick at 30 s | 80 | 60 | 42 |
| 2c brick at 60 s | 80 | 59 | 41 |
| 2c brick at 180 s | 76 | 56 | 31 |

The lower contact angles obtained by compositions according to example 3 showed that the addition of the trisiloxane surfactant can significantly improve the wetting of water based products on substrates previously treated with hydrophobing agents.

### Example 4

### Depth of Penetration of Water Based Silicone Water Repellents

The depth of penetration was measured by breaking the substrate and applying a water based dye to the new surface. Parts of the substrate which were not treated formerly by the water repellent composition were dyed then the penetration depth (DOP) of the water repellent treatment was measured with a ruler (reading in mm).

Two commercial water based silicone water repellents were used: Product 1 (Dow Corning® 520 water repellent) and a second Product 2 containing silicone resin, alkoxysilane, non ionic emulsifier and dimethylsiloxane (Dow Corning®IE-6683. A trisiloxane surfactant with an average of 7 EO units was added in different quantities and compared to the product containing no additive. Substrates were treated by means of brushing (one saturated coat) and 10% active ingredient was used for all measurements.

TABLE 3
Product 1 (Dow Corning ® 520)

| | Concrete | Brick |
|---|---|---|
| Treatment | DOP (mm) | DOP (mm) |
| Product 1 on substrate 2a | 0.5 | 3 |
| Product 1 plus 0.25% | 0.5 | 4 |
| trisiloxane on substrate 2a | | |
| Product 1 plus 0.5% | 1 | 8 |
| trisiloxane on substrate 2a | | |
| Product 1 on substrate 2b | 2 | 2 |
| Product 1 plus 0.25% | 2 | 4 |
| trisiloxane on substrate 2b | | |
| Product 1 plus 0.5% | 3 | 4 |
| trisiloxane on substrate 2b | | |
| Product 1 on substrate 2c | 1 | 2 |
| Product 1 plus 0.25% | 5 | 4 |
| trisiloxane on substrate 2c | | |
| Product 1 plus 0.5% | 9 | 8 |
| trisiloxane on substrate 2c | | |

Table 3 shows that the addition of trisiloxane surfactant increased the depth of penetration. An increased value generally means that treatments are more durable.

TABLE 4
Product 2 (Dow Corning ® IE-6683)

| | Concrete |
|---|---|
| Treatment | DOP (mm) |
| Product 2 on substrate 2a | 0.5 |
| Product 2 plus 0.25% | 1 |
| trisiloxane on substrate 2a | |
| Product 2 plus 0.5% | 1 |
| trisiloxane on substrate 2a | |
| Product 2 on substrate 2b | 3 |
| Product 2 plus 0.25% | 3 |
| trisiloxane on substrate 2b | |
| Product 2 plus 0.5% | 6 |
| trisiloxane on substrate 2b | |
| Product 2 on substrate 2c | 0 |
| Product 2 plus 0.25% | 7 |
| trisiloxane on substrate 2c | |
| Product 2 plus 0.5% | 7 |
| trisiloxane on substrate 2c | |

The results show that the depth of penetration was significantly improved when treating substrates that where already treated in the past.

By way of comparison, new concrete substrates were treated with Product 1 and with Product 2. The DOP was 0.5 mm.

Thus Table 4 shows that DOP reached with the compositions according to the invention could be much higher than for new substrates, i.e. substrates that were not treated before with water repellent composition.

### Example 5

### Water Absorption of Water Based Silicone Water Repellents

The water absorption was measured with a RILEM tube as described above. Two commercial water based silicone water repellents were used for the surface treatment (brushing, one saturated coat). Product 1 (Dow Corning® 520) containing alkoxysilane, non ionic emulsifier and methyl hydrogen polysiloxane and a second Product 2 containing silicone resin, alkoxysilane, non ionic emulsifier and dimethylsiloxane (Dow Corning® 6683) A trisiloxane surfactant with an average of 7 EC units (called additive in table 5 and 6) was added in different quantities and compared to the product containing no additive. 10% active ingredient was used for all measurement.

TABLE 5
Product 1

| | Concrete Water |
|---|---|
| | absorption |
| Treatment | 1/8/24 hour (ml) |
| Product 1 on substrate 2a | 0.05/0.8/1.85 |
| Product 1 plus 0.25% | 0.0/0.8/2.5 |
| additive on substrate 2a | |
| Product 1 plus 0.5% | 0.0/0.5/1.65 |
| additive on substrate 2a | |
| Product 1 on substrate 2b | 0.25/3.5/>4 |
| Product 1 plus 0.25% | 0.0/0.4/1.6 |
| additive on substrate 2b | |
| Product 1 plus 0.5% | 0.0/0.3/0.7 |
| additive on substrate 2b | |
| Product 1 on substrate 2c | 0.0/1.2/3.65 |
| Product 1 plus 0.25% | 0.1/1.1/3.95 |
| additive on substrate 2c | |
| Product 1 plus 0.5% | 0.1/1.0/3.5 |
| additive on substrate 2c | |

TABLE 6
Product 2

| | Concrete Water |
|---|---|
| | absorption |
| Treatment | 1/8/24 hour (ml) |
| Product 2 on substrate 2a | 0.1/0.6/1.7 |
| Product 2 plus 0.25% additive on substrate 2a | 0.0/0.1/0.3 |
| Product 2 plus 0.5% additive on substrate 2a | 0.0/0.25/0.8 |
| Product 2 on substrate 2b | 0.0/0.45/3.5 |
| Product 2 plus 0.25% additive on substrate 2b | 0.1/0.2/0.9 |
| Product 2 plus 0.5% additive on substrate 2b | 0.0/0.2/1 |
| Product 2 on substrate 2c | 0.2/0.9/2.35 |
| Product 2 plus 0.25% additive on substrate 2c | 0.0/0.15/0.6 |
| Product 2 plus 0.5% additive on substrate 2c | 0.05/0.45/1.4 |

The results show that the water absorption can be significantly improved when treating concrete that was already treated in the past. For product 2, some results are even better than for substrates which were not treated before (1.4 ml water absorption in 24 h for concrete only treated with product 2).

### Example 6

### Water Absorption of Water Based Silicone Water Repellents

The emulsions of Example 1 were used to treat substrates as described in example 2 and the water absorption was measured with a RILEM tube. Treatment was carried out by means of a brush (one saturated coat) 10% active ingredient was used for all treatment.

TABLE 7
Emulsion 1a

| | Concrete Water |
|---|---|
| | absorption |
| Treatment | 1/8/24 hour (ml) |
| Emulsion 1a on substrate 2a | 0.05/0.25/0.6 |
| Emulsion 1a on substrate 2b | 0.1/0.5/1.1 |
| Emulsion 1a on substrate 2c | 0.15/0.6/1.15 |

TABLE 8
Emulsion 1b

| | Concrete Water |
|---|---|
| | absorption |
| Treatment | 1/8/24 hour (ml) |
| Emulsion 1b on substrate 2a | 0.1/0.4/1.0 |
| Emulsion 1b on substrate 2b | 0.15/0.4/1.0 |
| Emulsion 1b on substrate 2c | 0.2/0.5/0.8 |

The results show that silicone water repellents of Example 1, made with a trisiloxane surfactant with an average of 7 EO units and containing no additional emulsifier were very efficient on concrete previously treated with hydrophobing agents.

1. A composition for improving the water repellency of a substrate, said composition contains a mixture formed by combining:
I water,
II at least one water-repellent silicon-containing compound which contains a silicone resin or an alkoxysilane,
III a siloxane surfactant containing:
i an alkylpoly(ethyleneoxy)siloxane group, and
ii an alkyl siloxane group, where the alkyl group contains 1-6 carbon atoms, and
IV optionally an emulsifier.

2. The composition according to claim 1, wherein two or more water-repellent silicon-containing compounds (II) are present.

3. The composition according to claim 1, wherein the water-repellent silicon-containing compound (II) contains a silicone resin compound which is a MQ or RSiO_{3/2} resin where R is hydrogen, aryl or alkyl with 1-12 carbon atoms.

4. The composition according to claim 1, wherein the water-repellent silicon-containing compound (III) contains an alkoxysilane compound which is alkyltrialkoxysilane with 1-12 carbon atoms in the alkyl chain and 1-6 carbons in the alkoxy chain.

5. The composition according to claim 1, wherein the water-repellent silicon-containing compound (II) contains a polysiloxane compound which is a diorganosiloxane with 1-12 carbon atoms per organic group.

6. The composition according to claim 1, wherein the siloxane surfactant (III) contains from 2 to 8 silicon atoms.

7. The composition according to claim 1, wherein the siloxane surfactant (III) contains 1-3 alkylpoly(ethyleneoxy)siloxane groups (i) and 1 to 4 alkyl-siloxane groups (ii).

8. The composition according to claim 1, wherein the siloxane surfactant (III) is a trisiloxane containing one alkylypoly(ethyleneoxy)siloxane group (i) and two methyl- and/or ethyl-siloxane groups (ii).

9. The composition according to claim 1, wherein the average number of ethyleneoxy (EO) units in the alkylpoly(ethyleneoxy)siloxane group (ii) is comprised between 5 and 12.

10. The composition according to claim 1, wherein the end unit of the alkylpoly(ethyleneoxy)siloxane group (ii) is an acetoxy, hydroxyl or methoxy unit.

11. The composition according to claim 1, wherein the siloxane surfactant (III) is a methyltrisiloxane containing two groups (ii) wherein the alkyl parts are methyl, and one group (i) with an average number of ethyleneoxy (EO) units of 7 and a hydroxyl end unit.

12. The composition according to claim 1, wherein the composition is emulsified.

13. The composition according to claim 1, wherein the weight ratio of siloxane surfactant (III) to water-repellent silicon-containing compound (II) is composed between 1:100 to 10:100.

14. A process for improving the water repellency of a substrate by treating the substrate with a composition containing a mixture formed by combining:
I water,
II at least one water-repellent silicon-containing compound, which contains a silicone resin or an alkoxysilane,
III a siloxane surfactant containing:
i an alkylpoly(ethyleneoxy)siloxane group, and
ii an alkyl siloxane group, where the alkyl group contains 1-6 carbon atoms, and
IV optionally an emulsifier.

15. The process according to claim 14 where the substrate is concrete, masonry, stucco, natural or artificial stone, ceramic, terracotta bricks, plaster board, fiber cement board, or other cement containing products, wood particle board, wood plastic composite, oriented strand board or wood.

16. The process according to claim 14, where the composition is either applied to the surface of a substrate previously treated with a hydrophobing agent or is included in the starting materials before or during manufacture of the substrate.

17. A process of preparing a water-repellent emulsion by
combining:
I water,
II at least one water-repellent silicon-containing compound, which contains a silicone resin or an alkoxysilane,
III a siloxane surfactant containing:
i an alkylpoly(ethyleneoxy)siloxane group, and
ii an alkyl siloxane group, where the alkyl group contains 1-6 carbon atoms, and
IV optionally an emulsifier
shearing the dispersion to form an emulsion, and
admixing additional water and optionally an additional ingredient.

18. A process of using the composition according to claim 1 to improve water repellency of a substrate, said process comprising applying the composition to the finished substrate or including the composition during the production of the substrate.
